(19) United States
(12) Patent Application Publication
(10) Pub. No.: US 2025/0265491 A1
(43) Pub. Date: Aug. 21, 2025

(54) System, Method, and Computer Program Product for Quantifying Contributions of Prior Inputs in Sequence-Based Machine Learning Models

(71) Applicant: Visa International Service Association, San Francisco, CA (US)

(72) Inventors: Weijia Xu, Austin, TX (US); Xi Kan, Austin, TX (US); Dan Wang, Cedar Park, TX (US)

(21) Appl. No.: 18/583,120

(22) Filed: Feb. 21, 2024

(51) Int. Cl. G06N 20/00; G06Q 20/40

(52) U.S. Cl. CPC G06N 20/00; G06Q 20/401

(57) ABSTRACT

Systems, methods, and computer program products are provided for quantifying contributions of prior inputs in sequence-based machine learning models. The system includes at least one processor configured to: obtain input data associated with a sequence of inputs to be processed by a machine learning model to generate a model output associated with a current input; learn, based on the input data, using a time decay attribution model, a time decay factor; generate, based on the time decay factor, a temporal contribution of the inputs; generate, based on how machine learning model inference results change independently for the inputs, individual contributions of the inputs; and combine the temporal contributions and the individual contributions of the inputs to determine combined contributions of the inputs prior to the current input to the model output associated with the current input.

### BACKGROUND

### 1. Technical Field

This disclosure relates generally to sequence models and, in non-limiting embodiments or aspects, to systems, methods, and computer program products for quantifying contributions of prior inputs in sequence-based machine learning models.

### 2. Technical Considerations

Payment ecosystem players (e.g., merchants, issuers, etc.) may want to receive interpretable reasons for output decisions of machine learning models for explainability and audit purposes. In a payment system, a decision model may often consider not only a current transaction, but also impacts from transactions that occurred before the current transaction. Quantifying an impact or contribution of these prior transactions is a challenging issue with a complexity that increases with a complexity of the underlying machine learning model.

### SUMMARY

Accordingly, provided are improved systems, methods, and computer program products for quantifying contributions of prior inputs in sequence-based machine learning models.

According to non-limiting embodiments or aspects, provided is a system including: at least one processor configured to: obtain input data associated with a sequence of transactions to be processed by a machine learning model to generate a model output associated with a current transaction; learn, based on the input data, using a time decay attribution model, a time decay factor; for each block of one or more transactions of a plurality of blocks of one or more transactions in the sequence of transactions: generate, based on the time decay factor and a time before the current transaction, an impact associated with that block of one or more transactions at the time before the current transaction; generate, based on a difference between the model output and a modified model output generated by the machine learning model processing a modified sequence of transactions in which transactions in the sequence of transactions before that block of one or more transactions are truncated, an individual contribution associated with that block of one or more transactions; generate, based on the individual contribution associated with that block of one or more transactions and the impact associated with that block of one or more transactions at the time before the current transaction, a current contribution associated with that block of one or more transactions; and provide the current contribution associated with that block of one or more transactions in association with the model output associated with the current transaction.

In some non-limiting embodiments or aspects, the at least one processor is further configured to: determine, based on the combined contribution associated with each block of one or more transactions, at least one of (i) a block of one or more transactions of the plurality of blocks of one or more transactions in the sequence of transactions with a greatest contribution toward the model output associated with the current transaction and (ii) a block of one or more transactions of the plurality of blocks of one or more transactions in the sequence of transactions with a greatest contribution against the model output associated with the current transaction.

In some non-limiting embodiments or aspects, the time decay attribution model includes an exponential distribution defined according to the following Equation:

$$w = \frac{1}{β} {e}^{- \frac{x}{β}}$$

where x denotes a time before the current transaction and x>0, w denotes an impact for transactions that happened at x with regard to a current time associated with the current transaction, and β is the time decay factor.

In some non-limiting embodiments or aspects, the at least one processor is configured to learn, based on the input data, using the time decay attribution model, the time decay factor by: constructing N new transaction series based on the input data; computing N samples of x and w for the N new transaction series; and estimating the time decay factor β from the N samples using a Maximum Likelihood Estimation (MLE) method.

In some non-limiting embodiments or aspects, a transaction processing system includes the at least one processor, and wherein the at least one processor is further configured to: receive, from a merchant system in an electronic payment processing network, an authorization request associated with the current transaction, wherein the authorization request includes transaction data associated with the current transaction, and wherein the transaction data includes an account identifier; communicate, to an issuer system in the electronic payment processing network and associated with the account identifier, the authorization request; in response to communicating the authorization request to the issuer system, initiate, a response timer associated with the transaction; in response to the response timer satisfying a response time amount without receiving, from the issuer system, an authorization response associated with the authorization request, process, using the machine learning model, the input data associated with the sequence of transactions and the transaction data associated with the current transaction, to generate the model output associated with the current transaction, wherein the model output includes an indication of whether to approve or deny the current transaction; generate, based on the model output, a stand-in response, wherein the stand-in response includes one of an approval and a denial of the current transaction in the electronic payment processing network; communicate, to the merchant system, the stand-in response; communicate, to the issuer system, at least one current contribution associated with at least one block of one or more transactions in association with the model output associated with the current transaction.

In some non-limiting embodiments or aspects, the at least one processor is configured to learn, based on the input data, using the time decay attribution model, the time decay factor offline before the model output associated with the current transaction is generated.

In some non-limiting embodiments or aspects, the at least one processor is further configured to: communicate, to the merchant system, the at least one current contribution associated with the at least one block of one or more transactions in association with the stand-in response.

According to non-limiting embodiments or aspects, provided is a method including: obtaining, with at least one processor, input data associated with a sequence of transactions to be processed by a machine learning model to generate a model output associated with a current transaction; learning, with the at least one processor, based on the input data, using a time decay attribution model, a time decay factor; for each block of one or more transactions of a plurality of blocks of one or more transactions in the sequence of transactions: generating, with the at least one processor, based on the time decay factor and a time before the current transaction, an impact associated with that block of one or more transactions at the time before the current transaction; generating, with the at least one processor, based on a difference between the model output and a modified model output generated by the machine learning model processing a modified sequence of transactions in which transactions in the sequence of transactions before that block of one or more transactions are truncated, an individual contribution associated with that block of one or more transactions; generating, with the at least one processor, based on the individual contribution associated with that block of one or more transactions and the impact associated with that block of one or more transactions at the time before the current transaction, a current contribution associated with that block of one or more transactions; and providing, with the at least one processor, the current contribution associated with that block of one or more transactions in association with the model output associated with the current transaction.

In some non-limiting embodiments or aspects, the method further includes: determining, with the at least one processor, based on the combined contribution associated with each block of one or more transactions, at least one of (i) a block of one or more transactions of the plurality of blocks of one or more transactions in the sequence of transactions with a greatest contribution toward the model output associated with the current transaction and (ii) a block of one or more transactions of the plurality of blocks of one or more transactions in the sequence of transactions with a greatest contribution against the model output associated with the current transaction.

In some non-limiting embodiments or aspects, the time decay attribution model includes an exponential distribution defined according to the following Equation:

$$w = \frac{1}{β} {e}^{- \frac{x}{β}}$$

where x denotes a time before the current transaction and x>0, w denotes an impact for transactions that happened at x with regard to a current time associated with the current transaction, and β is the time decay factor.

In some non-limiting embodiments or aspects, learning, with the at least one processor, based on the input data, using the time decay attribution model, the time decay factor includes: constructing, with the at least one processor, N new transaction series based on the input data; computing, with the at least one processor, N samples of x and w for the N new transaction series; and estimating, with the at least one processor, the time decay factor β from the N samples using a Maximum Likelihood Estimation (MLE) method.

In some non-limiting embodiments or aspects, a transaction processing system includes the at least one processor, and wherein the method further includes: receiving, with the at least one processor of the transaction processing system, from a merchant system in an electronic payment processing network, an authorization request associated with the current transaction, wherein the authorization request includes transaction data associated with the current transaction, and wherein the transaction data includes an account identifier; communicating, with the at least one processor of the transaction processing system, to an issuer system in the electronic payment processing network and associated with the account identifier, the authorization request; in response to communicating the authorization request to the issuer system, initiating, with the at least one processor of the transaction processing system, a response timer associated with the transaction; in response to the response timer satisfying a response time amount without receiving, from the issuer system, an authorization response associated with the authorization request, processing, with the at least one processor of the transaction processing system, using the machine learning model, the input data associated with the sequence of transactions and the transaction data associated with the current transaction, to generate the model output associated with the current transaction, wherein the model output includes an indication of whether to approve or deny the current transaction; generating, with the at least one processor of the transaction processing system, based on the model output, a stand-in response, wherein the stand-in response includes one of an approval and a denial of the current transaction in the electronic payment processing network; communicating, with the at least one processor of the transaction processing system, to the merchant system, the stand-in response; communicating, with the at least one processor of the transaction processing system, to the issuer system, at least one current contribution associated with at least one block of one or more transactions in association with the model output associated with the current transaction.

In some non-limiting embodiments or aspects, the time decay factor is learned, based on the input data, using the time decay attribution model, offline before the model output associated with the current transaction is generated.

In some non-limiting embodiments or aspects, the method further includes: communicating, with the at least one processor of the transaction processing system, to the merchant system, the at least one current contribution associated with the at least one block of one or more transactions in association with the stand-in response.

According to non-limiting embodiments or aspects, provided is a computer program product, including at least one non-transitory computer-readable medium including program instructions that, when executed by at least one processor, cause the at least one processor to: obtain input data associated with a sequence of transactions to be processed by a machine learning model to generate a model output associated with a current transaction; learn, based on the input data, using a time decay attribution model, a time decay factor; for each block of one or more transactions of a plurality of blocks of one or more transactions in the sequence of transactions: generate, based on the time decay factor and a time before the current transaction, an impact associated with that block of one or more transactions at the time before the current transaction; generate, based on a difference between the model output and a modified model output generated by the machine learning model processing a modified sequence of transactions in which transactions in the sequence of transactions before that block of one or more transactions are truncated, an individual contribution associated with that block of one or more transactions; generate, based on the individual contribution associated with that block of one or more transactions and the impact associated with that block of one or more transactions at the time before the current transaction, a current contribution associated with that block of one or more transactions; provide the current contribution associated with that block of one or more transactions in association with the model output associated with the current transaction.

In some non-limiting embodiments or aspects, the program instructions, when executed by the at least one processor, further cause the at least one processor to: determine, based on the combined contribution associated with each block of one or more transactions, at least one of (i) a block of one or more transactions of the plurality of blocks of one or more transactions in the sequence of transactions with a greatest contribution toward the model output associated with the current transaction and (ii) a block of one or more transactions of the plurality of blocks of one or more transactions in the sequence of transactions with a greatest contribution against the model output associated with the current transaction.

In some non-limiting embodiments or aspects, the time decay attribution model includes an exponential distribution defined according to the following Equation:

$$w = \frac{1}{β} {e}^{- \frac{x}{β}}$$

where x denotes a time before the current transaction and x>0, w denotes an impact for transactions that happened at x with regard to a current time associated with the current transaction, and β is the time decay factor.

In some non-limiting embodiments or aspects, the program instructions, when executed by the at least one processor, cause the at least one processor to learn, based on the input data, using the time decay attribution model, the time decay factor by: constructing N new transaction series based on the input data; computing N samples of x and w for the N new transaction series; and estimating the time decay factor β from the N samples using a Maximum Likelihood Estimation (MLE) method.

In some non-limiting embodiments or aspects, a transaction processing system includes the at least one processor, and, wherein the program instructions, when executed by the at least one processor, further cause the at least one processor to: receive, from a merchant system in an electronic payment processing network, an authorization request associated with the current transaction, wherein the authorization request includes transaction data associated with the current transaction, and wherein the transaction data includes an account identifier; communicate, to an issuer system in the electronic payment processing network and associated with the account identifier, the authorization request; in response to communicating the authorization request to the issuer system, initiate, a response timer associated with the transaction; in response to the response timer satisfying a response time amount without receiving, from the issuer system, an authorization response associated with the authorization request, process, using the machine learning model, the input data associated with the sequence of transactions and the transaction data associated with the current transaction, to generate the model output associated with the current transaction, wherein the model output includes an indication of whether to approve or deny the current transaction; generate, based on the model output, a stand-in response, wherein the stand-in response includes one of an approval and a denial of the current transaction in the electronic payment processing network; communicate, to the merchant system, the stand-in response; communicate, to the issuer system, at least one current contribution associated with at least one block of one or more transactions in association with the model output associated with the current transaction.

In some non-limiting embodiments or aspects, the program instructions, when executed by the at least one processor, cause the at least one processor to learn, based on the input data, using the time decay attribution model, the time decay factor offline before the model output associated with the current transaction is generated, and wherein the program instructions, when executed by the at least one processor, further cause the at least one processor to: communicate, to the merchant system, the at least one current contribution associated with the at least one block of one or more transactions in association with the stand-in response.

Further non-limiting embodiments or aspects are set forth in the following numbered clauses:

Clause 1: A system including: at least one processor configured to: obtain input data associated with a sequence of transactions to be processed by a machine learning model to generate a model output associated with a current transaction; learn, based on the input data, using a time decay attribution model, a time decay factor; for each block of one or more transactions of a plurality of blocks of one or more transactions in the sequence of transactions: generate, based on the time decay factor and a time before the current transaction, an impact associated with that block of one or more transactions at the time before the current transaction; generate, based on a difference between the model output and a modified model output generated by the machine learning model processing a modified sequence of transactions in which transactions in the sequence of transactions before that block of one or more transactions are truncated, an individual contribution associated with that block of one or more transactions; generate, based on the individual contribution associated with that block of one or more transactions and the impact associated with that block of one or more transactions at the time before the current transaction, a current contribution associated with that block of one or more transactions; and provide the current contribution associated with that block of one or more transactions in association with the model output associated with the current transaction.

Clause 2: The system of clause 1, wherein the at least one processor is further configured to: determine, based on the combined contribution associated with each block of one or more transactions, at least one of (i) a block of one or more transactions of the plurality of blocks of one or more transactions in the sequence of transactions with a greatest contribution toward the model output associated with the current transaction and (ii) a block of one or more transactions of the plurality of blocks of one or more transactions in the sequence of transactions with a greatest contribution against the model output associated with the current transaction.

Clause 3: The system of clause 1 or 2, wherein the time decay attribution model includes an exponential distribution defined according to the following Equation:

$$w = \frac{1}{β} {e}^{- \frac{x}{β}}$$

where x denotes a time before the current transaction and x>0, w denotes an impact for transactions that happened at x with regard to a current time associated with the current transaction, and β is the time decay factor.

Clause 4: The system of any of clauses 1-3, wherein the at least one processor is configured to learn, based on the input data, using the time decay attribution model, the time decay factor by: constructing N new transaction series based on the input data; computing N samples of x and w for the N new transaction series; and estimating the time decay factor β from the N samples using a Maximum Likelihood Estimation (MLE) method.

Clause 5: The system of any of clauses 1-4, wherein a transaction processing system includes the at least one processor, and wherein the at least one processor is further configured to: receive, from a merchant system in an electronic payment processing network, an authorization request associated with the current transaction, wherein the authorization request includes transaction data associated with the current transaction, and wherein the transaction data includes an account identifier; communicate, to an issuer system in the electronic payment processing network and associated with the account identifier, the authorization request; in response to communicating the authorization request to the issuer system, initiate, a response timer associated with the transaction; in response to the response timer satisfying a response time amount without receiving, from the issuer system, an authorization response associated with the authorization request, process, using the machine learning model, the input data associated with the sequence of transactions and the transaction data associated with the current transaction, to generate the model output associated with the current transaction, wherein the model output includes an indication of whether to approve or deny the current transaction; generate, based on the model output, a stand-in response, wherein the stand-in response includes one of an approval and a denial of the current transaction in the electronic payment processing network; communicate, to the merchant system, the stand-in response; and communicate, to the issuer system, at least one current contribution associated with at least one block of one or more transactions in association with the model output associated with the current transaction.

Clause 6: The system of any of clauses 1-5, wherein the at least one processor is configured to learn, based on the input data, using the time decay attribution model, the time decay factor offline before the model output associated with the current transaction is generated.

Clause 7: The system of any of clauses 1-6, wherein the at least one processor is further configured to: communicate, to the merchant system, the at least one current contribution associated with the at least one block of one or more transactions in association with the stand-in response.

Clause 8: A method comprising: obtaining, with at least one processor, input data associated with a sequence of transactions to be processed by a machine learning model to generate a model output associated with a current transaction; learning, with the at least one processor, based on the input data, using a time decay attribution model, a time decay factor; for each block of one or more transactions of a plurality of blocks of one or more transactions in the sequence of transactions: generating, with the at least one processor, based on the time decay factor and a time before the current transaction, an impact associated with that block of one or more transactions at the time before the current transaction; generating, with the at least one processor, based on a difference between the model output and a modified model output generated by the machine learning model processing a modified sequence of transactions in which transactions in the sequence of transactions before that block of one or more transactions are truncated, an individual contribution associated with that block of one or more transactions; generating, with the at least one processor, based on the individual contribution associated with that block of one or more transactions and the impact associated with that block of one or more transactions at the time before the current transaction, a current contribution associated with that block of one or more transactions; providing, with the at least one processor, the current contribution associated with that block of one or more transactions in association with the model output associated with the current transaction.

Clause 9: The method of clause 8, further comprising: determining, with the at least one processor, based on the combined contribution associated with each block of one or more transactions, at least one of (i) a block of one or more transactions of the plurality of blocks of one or more transactions in the sequence of transactions with a greatest contribution toward the model output associated with the current transaction and (ii) a block of one or more transactions of the plurality of blocks of one or more transactions in the sequence of transactions with a greatest contribution against the model output associated with the current transaction.

Clause 10: The method of clause 8 or 9, wherein the time decay attribution model includes an exponential distribution defined according to the following Equation:

$$w = \frac{1}{β} {e}^{- \frac{x}{β}}$$

where x denotes a time before the current transaction and x>0, w denotes an impact for transactions that happened at x with regard to a current time associated with the current transaction, and β is the time decay factor.

Clause 11: The method of any of clauses 8-10, wherein learning, with the at least one processor, based on the input data, using the time decay attribution model, the time decay factor includes: constructing, with the at least one processor, N new transaction series based on the input data; computing, with the at least one processor, N samples of x and w for the N new transaction series; and estimating, with the at least one processor, the time decay factor β from the N samples using a Maximum Likelihood Estimation (MLE) method.

Clause 12: The method of any of clauses 8-11, wherein a transaction processing system includes the at least one processor, and wherein the method further comprises: receiving, with the at least one processor of the transaction processing system, from a merchant system in an electronic payment processing network, an authorization request associated with the current transaction, wherein the authorization request includes transaction data associated with the current transaction, and wherein the transaction data includes an account identifier; communicating, with the at least one processor of the transaction processing system, to an issuer system in the electronic payment processing network and associated with the account identifier, the authorization request; in response to communicating the authorization request to the issuer system, initiating, with the at least one processor of the transaction processing system, a response timer associated with the transaction; in response to the response timer satisfying a response time amount without receiving, from the issuer system, an authorization response associated with the authorization request, processing, with the at least one processor of the transaction processing system, using the machine learning model, the input data associated with the sequence of transactions and the transaction data associated with the current transaction, to generate the model output associated with the current transaction, wherein the model output includes an indication of whether to approve or deny the current transaction; generating, with the at least one processor of the transaction processing system, based on the model output, a stand-in response, wherein the stand-in response includes one of an approval and a denial of the current transaction in the electronic payment processing network; communicating, with the at least one processor of the transaction processing system, to the merchant system, the stand-in response; and communicating, with the at least one processor of the transaction processing system, to the issuer system, at least one current contribution associated with at least one block of one or more transactions in association with the model output associated with the current transaction.

Clause 13: The method of any of clauses 8-12, wherein the time decay factor is learned, based on the input data, using the time decay attribution model, offline before the model output associated with the current transaction is generated.

Clause 14: The method of any of clauses 8-13, further comprising: communicating, with the at least one processor of the transaction processing system, to the merchant system, the at least one current contribution associated with the at least one block of one or more transactions in association with the stand-in response.

Clause 15: A computer program product, comprising at least one non-transitory computer-readable medium including program instructions that, when executed by at least one processor, cause the at least one processor to: obtain input data associated with a sequence of transactions to be processed by a machine learning model to generate a model output associated with a current transaction; learn, based on the input data, using a time decay attribution model, a time decay factor; for each block of one or more transactions of a plurality of blocks of one or more transactions in the sequence of transactions: generate, based on the time decay factor and a time before the current transaction, an impact associated with that block of one or more transactions at the time before the current transaction; generate, based on a difference between the model output and a modified model output generated by the machine learning model processing a modified sequence of transactions in which transactions in the sequence of transactions before that block of one or more transactions are truncated, an individual contribution associated with that block of one or more transactions; generate, based on the individual contribution associated with that block of one or more transactions and the impact associated with that block of one or more transactions at the time before the current transaction, a current contribution associated with that block of one or more transactions; and provide the current contribution associated with that block of one or more transactions in association with the model output associated with the current transaction.

Clause 16: The computer program product of clause 15, wherein the program instructions, when executed by the at least one processor, further cause the at least one processor to: determine, based on the combined contribution associated with each block of one or more transactions, at least one of (i) a block of one or more transactions of the plurality of blocks of one or more transactions in the sequence of transactions with a greatest contribution toward the model output associated with the current transaction and (ii) a block of one or more transactions of the plurality of blocks of one or more transactions in the sequence of transactions with a greatest contribution against the model output associated with the current transaction.

Clause 17: The computer program product of clause 15 or 16, wherein the time decay attribution model includes an exponential distribution defined according to the following Equation:

$$w = \frac{1}{β} {e}^{- \frac{x}{β}}$$

where x denotes a time before the current transaction and x>0, w denotes an impact for transactions that happened at x with regard to a current time associated with the current transaction, and β is the time decay factor.

Clause 18: The computer program product of any of clauses 15-17, wherein the program instructions, when executed by the at least one processor, cause the at least one processor to learn, based on the input data, using the time decay attribution model, the time decay factor by: constructing N new transaction series based on the input data; computing N samples of x and w for the N new transaction series; and estimating the time decay factor β from the N samples using a Maximum Likelihood Estimation (MLE) method.

Clause 19: The computer program product of any of clauses 15-18, wherein a transaction processing system includes the at least one processor, and, wherein the program instructions, when executed by the at least one processor, further cause the at least one processor to: receive, from a merchant system in an electronic payment processing network, an authorization request associated with the current transaction, wherein the authorization request includes transaction data associated with the current transaction, and wherein the transaction data includes an account identifier; communicate, to an issuer system in the electronic payment processing network and associated with the account identifier, the authorization request; in response to communicating the authorization request to the issuer system, initiate, a response timer associated with the transaction; in response to the response timer satisfying a response time amount without receiving, from the issuer system, an authorization response associated with the authorization request, process, using the machine learning model, the input data associated with the sequence of transactions and the transaction data associated with the current transaction, to generate the model output associated with the current transaction, wherein the model output includes an indication of whether to approve or deny the current transaction; generate, based on the model output, a stand-in response, wherein the stand-in response includes one of an approval and a denial of the current transaction in the electronic payment processing network; communicate, to the merchant system, the stand-in response; and communicate, to the issuer system, at least one current contribution associated with at least one block of one or more transactions in association with the model output associated with the current transaction.

Clause 20: The computer program product of any of clauses 15-19, wherein the program instructions, when executed by the at least one processor, cause the at least one processor to learn, based on the input data, using the time decay attribution model, the time decay factor offline before the model output associated with the current transaction is generated, and wherein the program instructions, when executed by the at least one processor, further cause the at least one processor to: communicate, to the merchant system, the at least one current contribution associated with the at least one block of one or more transactions in association with the stand-in response.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for quantifying contributions of prior inputs in sequence-based machine learning models, according to some non-limiting embodiments or aspects;

FIG. 2 is a flow diagram of a method for quantifying contributions of prior inputs in sequence-based machine learning models, according to some non-limiting embodiments or aspects;

FIG. 3 illustrates a machine learning (ML) model that makes a prediction based on input data, according to some non-limiting embodiments or aspects;

FIG. 4 illustrates generation of new transaction series for assessing an impact of prior transactions over time, according to some non-limiting embodiments or aspects;

FIG. 5A shows an electronic payment processing network, according to non-limiting embodiments or aspects;

FIG. 5B is a flow diagram of an implementation of non-limiting embodiments or aspects of a method for quantifying contributions of prior inputs in sequence-based machine learning models for stand-in processing (STIP) in an electronic payment processing network; and

FIG. 6 is a schematic diagram of example components of one or more devices of FIG. 1, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

Explainable Artificial Intelligence (XAI) techniques attempt to explain a model decision by attributing impacts or contributions to input values. For example, existing XAI techniques may modify original input with different values (e.g., using perturbations, etc.) and observe how model inference changes. An impact or contribution of changed input features may be a function of the changes of model inference results. The 2021 paper by João Bento, André Cruz, Pedro Saleiro, Mário A. T. Figueiredo, and Pedro Bizarro entitled “TimeSHAP: Explaining Recurrent Models through Sequence Perturbations” provides an example of a sequence perturbation method which randomly perturbates values in input sequences at different time steps and estimates a contribution or impact of each time step using game theory.

Existing XAI techniques may have large computational costs and/or bias and inaccuracy due to approximations introduced in the practical computation process. Approximation may often be used to speed up the computations, such as in TimeSHAP. For example, older sequences may be grouped together to save computations, and the results may often be biased towards a most recent time step instead of alternative time measuring such as actual time elapsed due to the coupling of temporal impact modeling and feature value contribution computations.

Non-limiting embodiments or aspects of the present disclosure provide systems, methods, and computer program products for quantifying contributions of prior inputs in sequence-based machine learning models that obtain input data associated with a sequence of transactions to be processed by a machine learning model to generate a model output associated with a current transaction; learn, based on the input data, using a time decay attribution model, a time decay factor; for each block of one or more transactions of a plurality of blocks of one or more transactions in the sequence of transactions; generate, based on the time decay factor and a time before the current transaction, an impact associated with that block of one or more transactions at the time before the current transaction; generate, based on a difference between the model output and a modified model output generated by the machine learning model processing a modified sequence of transactions in which transactions in the sequence of transactions before that block of one or more transactions are truncated, an individual contribution associated with that block of one or more transactions; generate, based on the individual contribution associated with that block of one or more transactions and the impact associated with that block of one or more transactions at the time before the current transaction, a current contribution associated with that block of one or more transactions; provide the current contribution associated with that block of one or more transactions in association with the model output associated with the current transaction.

In this way, non-limiting embodiments or aspects of the present disclosure may use a time decay model, which may learn a time decay factor offline to achieve faster online computations, to model contributions of prior inputs or transactions over time and assess a contribution of each prior input or transaction (or block of inputs or transactions) individually to identify a block of inputs or transactions (e.g., one or more inputs or transactions, etc.) that contributed the most toward a current prediction. Accordingly, non-limiting embodiments or aspects of the present disclosure may provide for decoupling of temporal impact modeling and feature value importance computations, consideration of an actual time passed (e.g., elapsed time, etc., rather than just by a number of time steps in the sequences), a model agnostic approach that doesn't require perturbation, and a reduced overall computation cost that is linear to a number of the prior inputs or transactions.

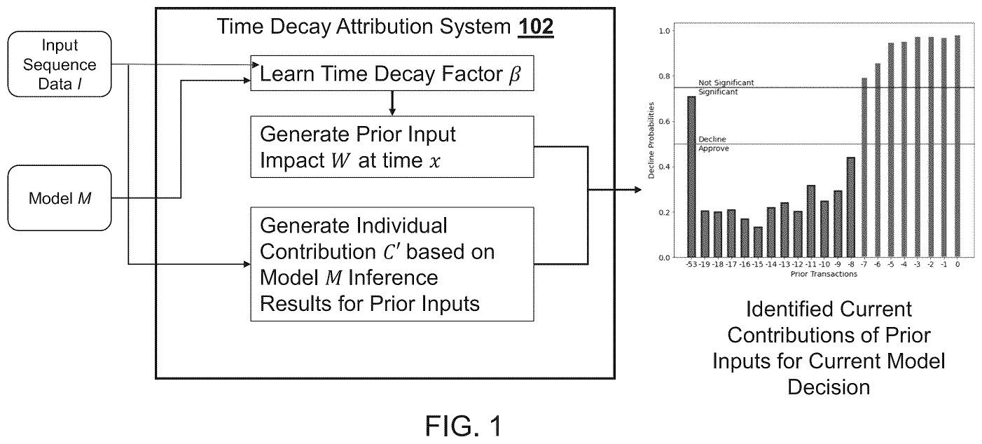

FIG. 1 is a schematic diagram of a system for quantifying contributions of prior inputs in sequence-based machine learning models, according to some non-limiting embodiments or aspects. As shown in FIG. 1, time decay attribution system 102 may be configured to obtain input sequence data I (e.g., transaction data, etc.) associated with a sequence of inputs (e.g., a sequence of transactions, etc.) to be processed by a ML model M (e.g., a STIP model, etc.) to generate a model output (e.g., a prediction, etc.) associated with a current input (e.g., a current transaction, etc.). Time decay attribution system 102 may be configured to learn, based on the input data I, using a time decay attribution model, a time decay factor β. Time decay attribution model 102 may be configured to generate, based on the time decay factor β and a time x before the current input, an impact W of the inputs at the time x before the current input. Time decay attribution system 102 may be configured to generate, based on how machine learning model M inference results change independently for the inputs prior to the current input, individual contributions C′ of the inputs prior to the current input. Time decay attribution system 102 may be configured to combine the impact W of the inputs at the time x before the current input (e.g., the temporal importance, etc.) and the individual contributions C′ of the inputs prior to the current input to determine combined contributions of the inputs prior to the current input to the model output associated with the current input.

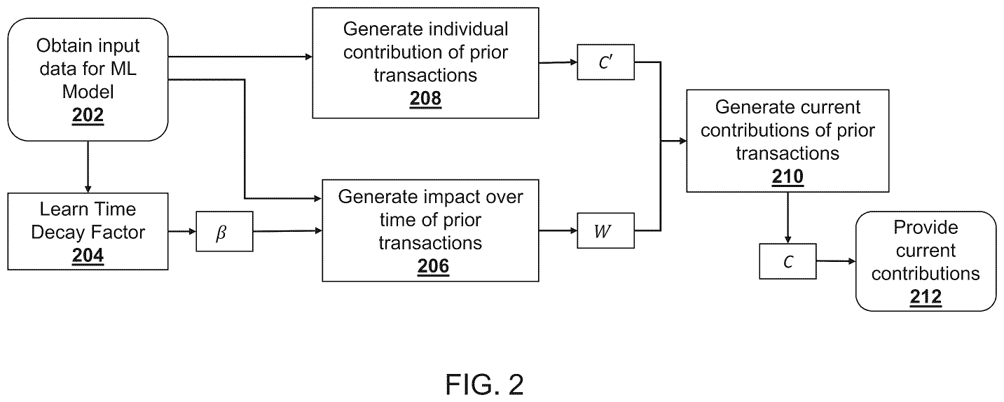

Referring now to FIG. 2, shown is a flow diagram for a method for quantifying contributions of prior inputs in sequence-based machine learning models, according to some non-limiting embodiments or aspects. The steps shown in FIG. 2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 2, at step 202, the method includes obtaining input data for a ML model. For example, time decay attribution system 102 may obtain input data I for ML model M. As an example, time decay attribution system 102 may obtain input data I associated with a sequence of transactions [v_{i,j}]_{0≤i≤t, 0≤j≤f} processed by an ML model M to generate a model output (e.g., a prediction P, etc.) associated with a current transaction. In such an example, input data I=[v_{i,j}]_{0≤i≤t, 0≤j≤f} may denote a sequence of payment transactions v, where t is a number of transactions, and f is the number of features in each transaction.

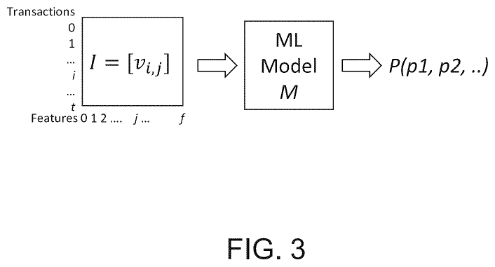

Referring now also to FIG. 3, which illustrates an ML model that makes a prediction based on input data, according to some non-limiting embodiments or aspects, ML model M may be configured to make a prediction P based on input data I, such that P=M(I). In such an example, a function X may determine a contribution c_{i,j} for each corresponding transaction v_{i,j} given prediction P. For example, a contribution C of input data I to a prediction P of ML model M may be defined according to the following Equation (1):

$$C = {[ {c}_{i , j} ]}_{0 \leq i \leq t , 0 \leq j \leq f} = X ( I , M , P ) . \qquad ( 1 )$$

In this way, non-limiting embodiments or aspects of the present disclosure may identify k consecutive prior transactions [v_{r . . . s}](e.g., a block of one or more transactions of a plurality of blocks of transactions in the sequence of transactions, etc.) such that [vₘ] contributed the most towards a current prediction P, for example, r, s=argmax(Σᵢ^{j}C_{i,j}|0≤i≤j<t), 0≤r≤s<t, and r−s≤k.

As shown in FIG. 2, at step 204, the method includes learning a time decay factor. For example, time decay attribution system 102 may learn a time decay factor β. As an example, time decay attribution system 102 may learn, based on the input data I, using a time decay attribution model, a time decay factor β. In this way, because an impact of a prior transaction may diminish over time, a time decay attribution model may enable more recent transactions to have more impact.

A time decay attribution model, according to non-limiting embodiments or aspects, may include an exponential distribution defined according to the following Equation (2):

$$w = \frac{1}{β} {e}^{- \frac{x}{β}} \qquad ( 2 )$$

where x denotes a time before the current transaction and x>0, w denotes an impact for transactions that happened at x with regard to a current time associated with the current transaction, and β is the time decay factor (e.g., a mean time decay factor, etc.), which is a learnable parameter.

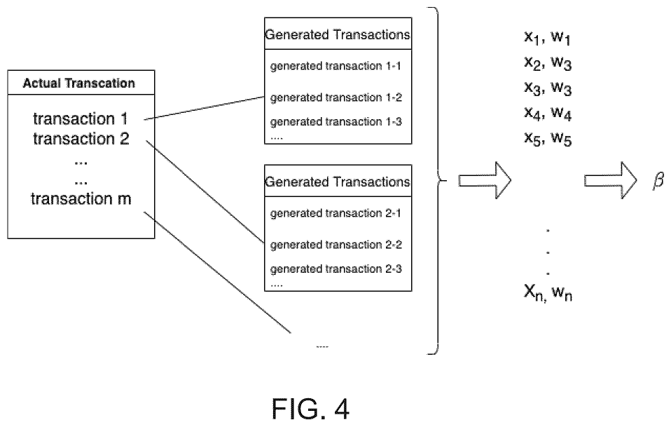

Referring now also to FIG. 4, time decay attribution system 102 may learn the time decay factor β by constructing N new transaction series I′ based on the input data I including the sequence of existing or prior transactions [v_{i,j}]_{0≤i≤t, 0≤j≤f}. For example, the new transaction series I′ may be generated according to the following Equation (3):

$$\begin{matrix}{I}^{′} = {[ {v}_{i , j} ]}_{0 \leq i \leq k , 0 \leq j \leq f} where k ∈ [ 1 , t - 1 ] , & {v}_{, j} = {v}_{t} .\end{matrix} \qquad ( 3 )$$

Time decay attribution system 102 may compute N samples of (x, w) where x=‥I|−|I′| and w=M(I′)−M(I). Time decay attribution system 102 may estimate the time decay factor β from the generated N samples of (x, w) using a Maximum Likelihood Estimation (MLE) method.

In some non-limiting embodiments or aspects, time decay attribution system 102 may learn, based on the input data, using the time decay attribution model, the time decay factor offline before the model output associated with the current transaction is generated, thereby reducing XAI online processing time when the current transaction is processed.

As shown in FIG. 2, at step 206, the method includes generating an impact over time of prior transactions. For example, time decay attribution system 102 may generate an impact over time W of prior transactions. As an example, time decay attribution system 102 may, for each block of one or more transactions of a plurality of blocks of one or more transactions in the sequence of transactions, generate, based on the time decay factor β and x time before the current transaction, an impact w associated with that block of one or more transactions at the time before the current transaction. In an example, time decay attribution system 102 may estimate impacts w of prior transactions at x time before the current transaction according to the following Equation (4):

$$w = \frac{1}{β} {e}^{- \frac{x}{β}} \qquad ( 4 )$$

where the impact over time W for all prior transactions is W={w₀, w₁, . . . wₜ₋₁}, where wᵢ>0.

As shown in FIG. 2, at step 208, the method includes generating an individual contribution of prior transactions. For example, time decay attribution system 102 may generate an individual contribution C′ of prior transactions. As an example, time decay attribution system 102 may, for each block of one or more transactions of the plurality of blocks of one or more transactions in the sequence of transactions, generate, based on a difference between the model output (e.g., the prediction P, etc.) and a modified model output (e.g., a modified prediction P′, etc.) generated by the ML model M processing a modified sequence of transactions in which transactions in the sequence of transactions before that block of one or more transactions are truncated, an individual contribution c′ associated with that block of one or more transactions. In such an example, a contribution of a prior transaction at k may be a function of a difference between the original model output and the model output of a modified sequence, in which the prior transactions are truncated before k. For example, given original input data I=[v_{i,j}]_{0≤i≤t, 0≤j≤f}, the contribution c′ₖ of a prior transaction vₖ towards the current prediction may be determined according to the following Equation (5):

$${c}_{k}^{′} = M ( I ) - M ( {[ {v}_{i , j} ]}_{0 \leq i \leq k - 1 , 0 \leq j \leq f} + {v}_{t} ) \qquad ( 5 )$$

where an individual contribution C′ of all prior transactions is C′=[c′₀, c′₁, . . . , c′ₜ₋₁], where c′ₖ>0 indicates the prior transaction k contributes towards the current model output, and c′ₖ<0 indicates the prior transaction k contributes against the current model output.

As shown in FIG. 2, at step 210, the method includes generating current contributions of prior transactions. For example, time decay attribution system 102 may generate current contributions C of prior transactions. As an example, time decay attribution system 102 may, for each block of one or more transactions of the plurality of blocks of one or more transactions in the sequence of transactions, generate, based on the individual contribution c′ associated with that block of one or more transactions and the impact w associated with that block of one or more transactions at the time before the current transaction, a current contribution c associated with that block of one or more transactions. In such an example, a contribution of each prior transaction vₖ in the original input data I may be defined according to the following Equation (6):

$$C = W * {C}^{′} ∝ [ {c}_{k} = {w}_{k} * {c}_{k}^{′} ] , \qquad ( 6 )$$

and time decay attribution system 102 may segment C into subgroups, so that the contribution of transactions in each subgroup shares a same sign, according to the following Equation (7):

$$C \to \{ {G}_{0 , i - 1} = \{ {c}_{0 … i - 1} \} , {G}_{i , j - 1} = \{ {c}_{i … j - 1} \} … {G}_{k , t - 1} = \{ {c}_{k … t - 1} \} \} . \qquad ( 7 )$$

In this way, prior transactions that contributed the most towards the current output may be argmax(Σᵢ^{j} cₖ|∀cₖ>0), and prior transactions that contributed the most against towards the current output may be argmax(−Σᵢ^{j} cₖ|∀ cₖ<0). For example, time decay attribution system 102 may determine, based on the combined contribution associated with each block of one or more transactions, at least one of (i) a block of one or more transactions of the plurality of blocks of one or more transactions in the sequence of transactions with a greatest contribution toward the model output associated with the current transaction and (ii) a block of one or more transactions of the plurality of blocks of one or more transactions in the sequence of transactions with a greatest contribution against the model output associated with the current transaction.

As shown in FIG. 2, at step 212, the method includes providing current contributions of prior transactions. For example, time decay attribution system 102 may provide current contributions C of prior transactions. As an example, time decay attribution system 102 may provide the current contribution c associated with that block of one or more transactions in association with the model output (e.g., the prediction P, etc.) associated with the current transaction. In such an example, time decay attribution system 102 may provide the block of one or more transactions that contributed the most towards the current output argmax(Σᵢ^{j} cₖ|∀cₖ>0) and/or the block of one or more transactions that contributed the most against towards the current output may be argmax(−Σᵢ^{j} cₖ|∀cₖ<0).

Accordingly, these current contributions of prior transactions may help model developers to determine if a model has any temporal bias. If there is unwanted bias towards a certain time period, the model developers may adjust the model accordingly. Otherwise, these current contributions of prior transactions may show the model is a fair model, which is also an advantageous property to confirm. For card support services, knowing the contributing transactions most impacting declined transactions may enable card support services to provide better explanations to customers in the event of inquiry and/or lead to better communications with cardholders. For policy makers, if any bias is identified in the model, the results may be used to improve their policies and strategies to better manage risk and customer satisfaction.

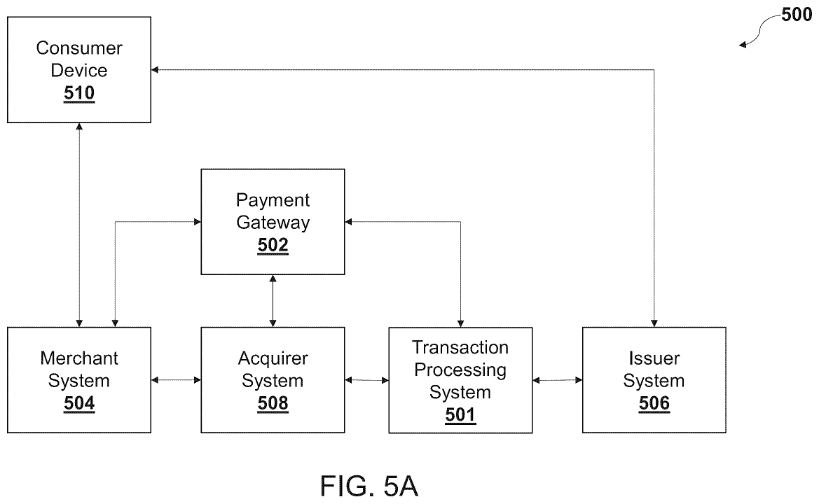

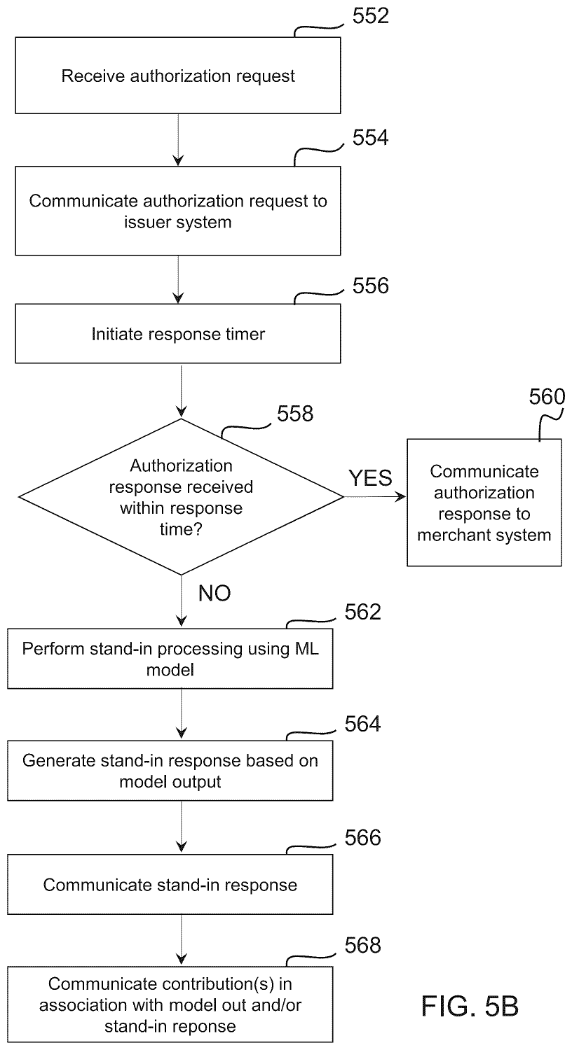

FIG. 5A shows an electronic payment processing network 500, according to non-limiting embodiments or aspects. The payment processing network may be used in conjunction with the systems and methods described herein. It will be appreciated that the particular arrangement of electronic payment processing network 500 shown is for example purposes only, and that various arrangements are possible. Transaction processing system 501 (e.g., a transaction handler, time decay attribution system 102, etc.) is shown to be in communication with one or more issuer systems (e.g., such as issuer system 506) and one or more acquirer systems (e.g., such as acquirer system 508). Although only single issuer system 506 and single acquirer system 508 are shown, it will be appreciated that transaction processing system 501 may be in communication with a plurality of issuer systems and/or acquirer systems. In some embodiments, transaction processing system 501 may also operate as an issuer system such that both transaction processing system 501 and issuer system 506 are a single system and/or controlled by a single entity.

In some non-limiting embodiments or aspects, transaction processing system 501 may communicate with merchant system 504 directly through a public or private network connection. Additionally or alternatively, transaction processing system 501 may communicate with merchant system 504 through payment gateway 502 and/or acquirer system 508. In some non-limiting embodiments or aspects, an acquirer system 508 associated with merchant system 504 may operate as payment gateway 502 to facilitate the communication of transaction requests from merchant system 504 to transaction processing system 501. Merchant system 504 may communicate with payment gateway 502 through a public or private network connection. For example, a merchant system 504 that includes a physical POS device may communicate with payment gateway 502 through a public or private network to conduct card-present transactions. As another example, a merchant system 504 that includes a server (e.g., a web server) may communicate with payment gateway 502 through a public or private network, such as a public Internet connection, to conduct card-not-present transactions.

In some non-limiting embodiments or aspects, transaction processing system 501, after receiving a transaction request from merchant system 504 that identifies an account identifier of a payor (e.g., such as an account holder) associated with a consumer device 510, may generate an authorization request message to be communicated to the issuer system 506 that issued the consumer device 510 and/or account identifier. Issuer system 506 may then approve or decline the authorization request and, based on the approval or denial, generate an authorization response message that is communicated to transaction processing system 501. Transaction processing system 501 may communicate an approval or denial to merchant system 504. When issuer system 506 approves the authorization request message, it may then clear and settle the payment transaction between the issuer system 506 and acquirer system 508.

In some non-limiting embodiments or aspects, transaction processing system 501, after receiving a transaction request from merchant system 504 that identifies an account identifier of a payor (e.g., such as an account holder) associated with an consumer device 510, may generate an authorization request message to be communicated to the issuer system 506 that issued the consumer device 510 and/or account identifier. However, issuer system 506 may be unable to provide a real-time response to transaction processing system 501, due to planned or unplanned outages or network problems. Transaction processing system 501 may then initiate STIP to determine whether to approve or decline the transaction and, based on the approval or denial, generate an authorization response message that is communicated to acquirer system 508 and/or merchant system 504.

Referring now to FIG. 5B, shown is a flow diagram of an implementation of non-limiting embodiments or aspects of a method for quantifying contributions of prior inputs in sequence-based machine learning models for STIP in an electronic payment processing network. The steps shown in FIG. 5B2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 5B, at step 552, the method includes receiving, from a merchant system 504 in an electronic payment processing network 500, an authorization request associated with the current transaction, wherein the authorization request includes transaction data associated with the current transaction, and wherein the transaction data includes an account identifier. For example, transaction processing system 501 may receive, from merchant system 504 in an electronic payment processing network 500 (e.g., via payment gateway 502, via acquirer system 508, etc.), an authorization request associated with the current transaction. The authorization request may include transaction data associated with the current transaction. The transaction data may include an account identifier (e.g., a PAN, etc.).

Transaction data may include parameters associated with a transaction, such as an account identifier (e.g., a PAN, etc.), a transaction amount, a transaction date and time, a type of products and/or services associated with the transaction, a conversion rate of currency, a type of currency, a merchant type, a merchant name, a merchant location, a merchant category group (MCG), a merchant category code (MCC), a type of a POS terminal associated with merchant system 504, a type of merchant associated with merchant system 504, a country associated with merchant system 504, a country associated with issuer system 506, a season, a time of day, a processing code, or any combination thereof, and/or the like.

Merchant system 504 may receive an account identifier (e.g., a PAN, etc.) and/or other information associated with a payment device from a user (e.g., a cardholder, etc.). Merchant system 504 may communicate the authorization request to payment gateway 502 and/or acquirer system 508. Transaction processing system 501 may receive the authorization request from payment gateway 502 and/or acquirer system 508.

As shown in FIG. 5B, at step 554, the method includes communicating, to an issuer system 506 in the electronic payment processing network 500 and associated with the account identifier, the authorization request. For example, transaction processing system 501 may communicate, to issuer system 506 associated with the account identifier, the authorization request. As an example, issuer system 506 may be identified by the transaction data (e.g., a PAN, a bank identification number (BIN), etc.).

As shown in FIG. 5B, at step 556, the method includes in response to communicating the authorization request to the issuer system 506, initiating, a response timer associated with the transaction. For example, transaction processing system 501 may in response to communicating the authorization request to the issuer system 506, initiate a response timer associated with the transaction. As an example, the response timer may be configured with a static or predetermined timeout value, or the response timer may be configured with a dynamic timeout value, for example, as disclosed in U.S. Patent Application Publication No. 2023/0153816A1, filed Nov. 16, 2021, the contents of which is hereby incorporated by reference in its entirety.

As shown in FIG. 5B, at step 558, the method includes determining whether the response timer satisfies a predetermined response time amount without receiving, from the issuer system 506, an authorization response associated with the authorization request. For example, transaction processing system 501 may determine whether the response timer satisfies a predetermined response time amount without receiving, from the issuer system 506, an authorization response associated with the authorization request. As an example, transaction processing system 501 may determine whether an authorization response associated with the authorization request is received from issuer system 506 before the response timer satisfies a response time amount (e.g., a predetermined response time amount, a dynamic response time amount, before the response timer times out, etc.).

As shown in FIG. 5B, at step 560, if at step 558, an authorization response is determined to have been received within the response time, the method includes communicating an authorization response to a merchant system 504. For example, transaction processing system 501 may, in response to receiving, from issuer system 506, the authorization response associated with the authorization request before the response timer satisfies the response time amount (e.g., before the response timer times out, etc.), communicate the authorization response to merchant system 504, payment gateway 502, and/or acquirer system 508.

As shown in FIG. 5B, at step 562, if at step 558, an authorization response is determined to have not been received within the response time, the method includes processing, using the machine learning model, the input data associated with the sequence of transactions and the transaction data associated with the current transaction to generate the model output associated with the current transaction. For example, transaction processing system 501 may, in response to the response timer satisfying a response time amount without receiving, from issuer system 506, an authorization response associated with the authorization request, process, using the ML model M (e.g., a STIP model, etc.), the input data associated with the sequence of transactions and the transaction data associated with the current transaction, to generate the model output (e.g., the prediction P, etc.) associated with the current transaction. The model output may include an indication of whether to approve or deny the current transaction. In such an example, transaction processing system 501 may learn, based on the input data, using the time decay attribution model, the time decay factor #offline before the model output associated with the current transaction is generated (e.g., before the current transaction is received in electronic payment processing network 500 and/or by transaction processing system 501, etc.).

As shown in FIG. 5B, at step 564, the method includes generating, based on the model output, a stand-in response, wherein the stand-in response includes one of an approval and a denial of the current transaction in the electronic payment processing network 500. For example, transaction processing system 501 may generate, based on the model output (e.g., the prediction P, etc.), a stand-in response, wherein the stand-in response includes one of an approval and a denial of the current transaction in electronic payment processing network 500.

As shown in FIG. 5B, at step 566, the method includes communicating, to the merchant system 504, the stand-in response. For example, transaction processing system 501 may communicate, to merchant system 504 (e.g., via payment gateway 502, via acquirer system 508, etc.) the stand-in response.

In some non-limiting embodiments or aspects, transaction processing system 501 communicates, to merchant system 504 e.g., via payment gateway 502, via acquirer system 508, etc.), the at least one current contribution c associated with the at least one block of one or more transactions in association with the stand-in response. For example, transaction processing system 502 may communicate, to merchant system 504 (e.g., via payment gateway 502, via acquirer system 508, etc.), the block of one or more transactions that contributed the most towards the current output argmax(Σᵢ^{j} cₖ|∀cₖ>0) and/or the block of one or more transactions that contributed the most against towards the current output may be argmax(−Σᵢ^{j}cₖ|∀cₖ<0).

In this way, cardholders may be provided with knowledge about how their past card usage pattern may impact their future card usages (e.g., approve/decline, credit score, etc.) to help the cardholders adjust their usage pattern and/or avoid future unexpected situations. Or in other scenarios, it may help identify unusual/unauthorized activities.

As shown in FIG. 5B, at step 568, the method includes communicating, to the issuer system 506, at least one current contribution associated with at least one block of one or more transactions in association with the model output associated with the current transaction. For example, transaction processing system 501 may communicate, to issuer system 506, at least one current contribution c associated with at least one block of one or more transactions in association with the model output associated with the current transaction. For example, transaction processing system 501 may communicate, to issuer system 506, the block of one or more transactions that contributed the most towards the current output argmax(Σᵢ^{j}cₖ|∀cₖ>0) and/or the block of one or more transactions that contributed the most against towards the current output may be argmax(−Σᵢ^{j} cₖ|∀cₖ<0).

In this way, a card issuing bank may gain insights at an individual account level and/or provide personalized services/adjustment. For example, if high contributing transactions are large and frequent, issuer system 506 may be configured to automatically determine that the cardholder has a high spending capacity and/or automatically increase a spending limit associated with the account identifier of the cardholder.

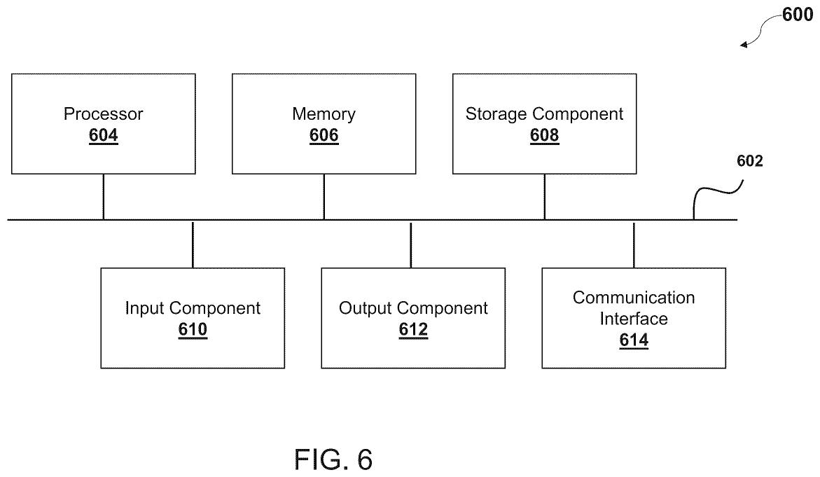

Referring now to FIG. 6, shown is a diagram of example components of a device 600 according to non-limiting embodiments. Device 600 may correspond to time decay attribution system 102 in FIG. 1, as an example. In some non-limiting embodiments, such systems or devices may include at least one device 600 and/or at least one component of device 600. The number and arrangement of components shown are provided as an example. In some non-limiting embodiments, device 600 may include additional components, fewer components, different components, or differently arranged components than those shown. Additionally, or alternatively, a set of components (e.g., one or more components) of device 600 may perform one or more functions described as being performed by another set of components of device 600.

As shown in FIG. 6, device 600 may include a bus 602, a processor 604, memory 606, a storage component 608, an input component 610, an output component 612, and a communication interface 614. Bus 602 may include a component that permits communication among the components of device 600. In some non-limiting embodiments, processor 604 may be implemented in hardware, firmware, or a combination of hardware and software. For example, processor 604 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 606 may include random access memory (RAM), read only memory (ROM), and/or another type of dynamic or static storage device (e.g., flash memory, magnetic memory, optical memory, etc.) that stores information and/or instructions for use by processor 604.

With continued reference to FIG. 6, storage component 608 may store information and/or software related to the operation and use of device 600. For example, storage component 608 may include a hard disk (e.g., a magnetic disk, an optical disk, a magneto-optic disk, a solid-state disk, etc.) and/or another type of computer-readable medium. Input component 610 may include a component that permits device 600 to receive information, such as via user input (e.g., a touch screen display, a keyboard, a keypad, a mouse, a button, a switch, a microphone, etc.). Additionally, or alternatively, input component 610 may include a sensor for sensing information (e.g., a global positioning system (GPS) component, an accelerometer, a gyroscope, an actuator, etc.). Output component 612 may include a component that provides output information from device 600 (e.g., a display, a speaker, one or more light-emitting diodes (LEDs), etc.). Communication interface 614 may include a transceiver-like component (e.g., a transceiver, a separate receiver and transmitter, etc.) that enables device 600 to communicate with other devices, such as via a wired connection, a wireless connection, or a combination of wired and wireless connections. Communication interface 614 may permit device 600 to receive information from another device and/or provide information to another device. For example, communication interface 614 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 600 may perform one or more processes described herein. Device 600 may perform these processes based on processor 604 executing software instructions stored by a computer-readable medium, such as memory 606 and/or storage component 608. A computer-readable medium may include any non-transitory memory device. A memory device includes memory space located inside of a single physical storage device or memory space spread across multiple physical storage devices. Software instructions may be read into memory 606 and/or storage component 608 from another computer-readable medium or from another device via communication interface 614. When executed, software instructions stored in memory 606 and/or storage component 608 may cause processor 604 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system comprising:
at least one processor configured to:
obtain input data associated with a sequence of transactions to be processed by a machine learning model to generate a model output associated with a current transaction;
learn, based on the input data, using a time decay attribution model, a time decay factor; and
for each block of one or more transactions of a plurality of blocks of one or more transactions in the sequence of transactions:
generate, based on the time decay factor and a time before the current transaction, an impact associated with that block of one or more transactions at the time before the current transaction;
generate, based on a difference between the model output and a modified model output generated by the machine learning model processing a modified sequence of transactions in which transactions in the sequence of transactions before that block of one or more transactions are truncated, an individual contribution associated with that block of one or more transactions;
generate, based on the individual contribution associated with that block of one or more transactions and the impact associated with that block of one or more transactions at the time before the current transaction, a current contribution associated with that block of one or more transactions; and
provide the current contribution associated with that block of one or more transactions in association with the model output associated with the current transaction.

2. The system of claim 1, wherein the at least one processor is further configured to:
determine, based on a combined contribution associated with each block of one or more transactions, at least one of (i) a block of one or more transactions of the plurality of blocks of one or more transactions in the sequence of transactions with a greatest contribution toward the model output associated with the current transaction and (ii) a block of one or more transactions of the plurality of blocks of one or more transactions in the sequence of transactions with a greatest contribution against the model output associated with the current transaction.

3. The system of claim 1, wherein the time decay attribution model includes an exponential distribution defined according to the following Equation:
$$w = \frac{1}{β} {e}^{- \frac{x}{β}}$$
where x denotes a time before the current transaction and x>0, w denotes an impact for transactions that happened at x with regard to a current time associated with the current transaction, and β is the time decay factor.

4. The system of claim 3, wherein the at least one processor is configured to learn, based on the input data, using the time decay attribution model, the time decay factor by:
constructing N new transaction series based on the input data;
computing N samples of x and w for the N new transaction series; and
estimating the time decay factor β from the N samples using a Maximum Likelihood Estimation (MLE) method.

5. The system of claim 1, wherein a transaction processing system includes the at least one processor, and wherein the at least one processor is further configured to:
receive, from a merchant system in an electronic payment processing network, an authorization request associated with the current transaction, wherein the authorization request includes transaction data associated with the current transaction, and wherein the transaction data includes an account identifier;
communicate, to an issuer system in the electronic payment processing network and associated with the account identifier, the authorization request;
in response to communicating the authorization request to the issuer system, initiate, a response timer associated with the transaction;
in response to the response timer satisfying a response time amount without receiving, from the issuer system, an authorization response associated with the authorization request, process, using the machine learning model, the input data associated with the sequence of transactions and the transaction data associated with the current transaction, to generate the model output associated with the current transaction, wherein the model output includes an indication of whether to approve or deny the current transaction;
generate, based on the model output, a stand-in response, wherein the stand-in response includes one of an approval and a denial of the current transaction in the electronic payment processing network;
communicate, to the merchant system, the stand-in response; and
communicate, to the issuer system, at least one current contribution associated with at least one block of one or more transactions in association with the model output associated with the current transaction.

6. The system of claim 5, wherein the at least one processor is configured to learn, based on the input data, using the time decay attribution model, the time decay factor offline before the model output associated with the current transaction is generated.

7. The system of claim 5, wherein the at least one processor is further configured to:
communicate, to the merchant system, the at least one current contribution associated with the at least one block of one or more transactions in association with the stand-in response.

8. A method comprising:
obtaining, with at least one processor, input data associated with a sequence of transactions to be processed by a machine learning model to generate a model output associated with a current transaction;
learning, with the at least one processor, based on the input data, using a time decay attribution model, a time decay factor; and
for each block of one or more transactions of a plurality of blocks of one or more transactions in the sequence of transactions:
generating, with the at least one processor, based on the time decay factor and a time before the current transaction, an impact associated with that block of one or more transactions at the time before the current transaction;
generating, with the at least one processor, based on a difference between the model output and a modified model output generated by the machine learning model processing a modified sequence of transactions in which transactions in the sequence of transactions before that block of one or more transactions are truncated, an individual contribution associated with that block of one or more transactions;
generating, with the at least one processor, based on the individual contribution associated with that block of one or more transactions and the impact associated with that block of one or more transactions at the time before the current transaction, a current contribution associated with that block of one or more transactions; and
providing, with the at least one processor, the current contribution associated with that block of one or more transactions in association with the model output associated with the current transaction.

9. The method of claim 8, further comprising:
determining, with the at least one processor, based on a combined contribution associated with each block of one or more transactions, at least one of (i) a block of one or more transactions of the plurality of blocks of one or more transactions in the sequence of transactions with a greatest contribution toward the model output associated with the current transaction and (ii) a block of one or more transactions of the plurality of blocks of one or more transactions in the sequence of transactions with a greatest contribution against the model output associated with the current transaction.

10. The method of claim 8, wherein the time decay attribution model includes an exponential distribution defined according to the following Equation:
$$w = \frac{1}{β} {e}^{- \frac{x}{β}}$$
where x denotes a time before the current transaction and x>0, w denotes an impact for transactions that happened at x with regard to a current time associated with the current transaction, and β is the time decay factor.

11. The method of claim 10, wherein learning, with the at least one processor, based on the input data, using the time decay attribution model, the time decay factor includes:
constructing, with the at least one processor, N new transaction series based on the input data;
computing, with the at least one processor, N samples of x and w for the N new transaction series; and
estimating, with the at least one processor, the time decay factor β from the N samples using a Maximum Likelihood Estimation (MLE) method.

12. The method of claim 8, wherein a transaction processing system includes the at least one processor, and wherein the method further comprises:
receiving, with the at least one processor of the transaction processing system, from a merchant system in an electronic payment processing network, an authorization request associated with the current transaction, wherein the authorization request includes transaction data associated with the current transaction, and wherein the transaction data includes an account identifier;
communicating, with the at least one processor of the transaction processing system, to an issuer system in the electronic payment processing network and associated with the account identifier, the authorization request;
in response to communicating the authorization request to the issuer system, initiating, with the at least one processor of the transaction processing system, a response timer associated with the transaction;
in response to the response timer satisfying a response time amount without receiving, from the issuer system, an authorization response associated with the authorization request, processing, with the at least one processor of the transaction processing system, using the machine learning model, the input data associated with the sequence of transactions and the transaction data associated with the current transaction, to generate the model output associated with the current transaction, wherein the model output includes an indication of whether to approve or deny the current transaction;
generating, with the at least one processor of the transaction processing system, based on the model output, a stand-in response, wherein the stand-in response includes one of an approval and a denial of the current transaction in the electronic payment processing network;
communicating, with the at least one processor of the transaction processing system, to the merchant system, the stand-in response; and
communicating, with the at least one processor of the transaction processing system, to the issuer system, at least one current contribution associated with at least one block of one or more transactions in association with the model output associated with the current transaction.

13. The method of claim 12, wherein the time decay factor is learned, based on the input data, using the time decay attribution model offline before the model output associated with the current transaction is generated.

14. The method of claim 12, further comprising:
communicating, with the at least one processor of the transaction processing system, to the merchant system, the at least one current contribution associated with the at least one block of one or more transactions in association with the stand-in response.

15. A computer program product, comprising at least one non-transitory computer-readable medium including program instructions that, when executed by at least one processor, cause the at least one processor to:
obtain input data associated with a sequence of transactions to be processed by a machine learning model to generate a model output associated with a current transaction;
learn, based on the input data, using a time decay attribution model, a time decay factor; and
for each block of one or more transactions of a plurality of blocks of one or more transactions in the sequence of transactions:
generate, based on the time decay factor and a time before the current transaction, an impact associated with that block of one or more transactions at the time before the current transaction;
generate, based on a difference between the model output and a modified model output generated by the machine learning model processing a modified sequence of transactions in which transactions in the sequence of transactions before that block of one or more transactions are truncated, an individual contribution associated with that block of one or more transactions;
generate, based on the individual contribution associated with that block of one or more transactions and the impact associated with that block of one or more transactions at the time before the current transaction, a current contribution associated with that block of one or more transactions; and
provide the current contribution associated with that block of one or more transactions in association with the model output associated with the current transaction.

16. The computer program product of claim 15, wherein the program instructions, when executed by the at least one processor, further cause the at least one processor to:
determine, based on a combined contribution associated with each block of one or more transactions, at least one of (i) a block of one or more transactions of the plurality of blocks of one or more transactions in the sequence of transactions with a greatest contribution toward the model output associated with the current transaction and (ii) a block of one or more transactions of the plurality of blocks of one or more transactions in the sequence of transactions with a greatest contribution against the model output associated with the current transaction.

17. The computer program product of claim 15, wherein the time decay attribution model includes an exponential distribution defined according to the following Equation:
$$w = \frac{1}{β} {e}^{- \frac{x}{β}}$$
where x denotes a time before the current transaction and x>0, w denotes an impact for transactions that happened at x with regard to a current time associated with the current transaction, and β is the time decay factor.

18. The computer program product of claim 17, wherein the program instructions, when executed by the at least one processor, cause the at least one processor to learn, based on the input data, using the time decay attribution model, the time decay factor by:
constructing N new transaction series based on the input data;
computing N samples of x and w for the N new transaction series; and
estimating the time decay factor β from the N samples using a Maximum Likelihood Estimation (MLE) method.

19. The computer program product of claim 15, wherein a transaction processing system includes the at least one processor, and wherein the program instructions, when executed by the at least one processor, further cause the at least one processor to:
receive, from a merchant system in an electronic payment processing network, an authorization request associated with the current transaction, wherein the authorization request includes transaction data associated with the current transaction, and wherein the transaction data includes an account identifier;
communicate, to an issuer system in the electronic payment processing network and associated with the account identifier, the authorization request;
in response to communicating the authorization request to the issuer system, initiate a response timer associated with the transaction;
in response to the response timer satisfying a response time amount without receiving, from the issuer system, an authorization response associated with the authorization request, process, using the machine learning model, the input data associated with the sequence of transactions and the transaction data associated with the current transaction to generate the model output associated with the current transaction, wherein the model output includes an indication of whether to approve or deny the current transaction;
generate, based on the model output, a stand-in response, wherein the stand-in response includes one of an approval and a denial of the current transaction in the electronic payment processing network;
communicate, to the merchant system, the stand-in response; and
communicate, to the issuer system, at least one current contribution associated with at least one block of one or more transactions in association with the model output associated with the current transaction.

20. The computer program product of claim 19, wherein the program instructions, when executed by the at least one processor, cause the at least one processor to learn, based on the input data, using the time decay attribution model, the time decay factor offline before the model output associated with the current transaction is generated, and wherein the program instructions, when executed by the at least one processor, further cause the at least one processor to:
communicate, to the merchant system, the at least one current contribution associated with the at least one block of one or more transactions in association with the stand-in response.
